(19) United States
(12) Patent Application Publication
(10) Pub. No.: US 2021/0022531 A1
(43) Pub. Date: Jan. 28, 2021

(54) COMPACT CUTLERY SET

(71) Applicant: COLD4GED INC., Toronto (CA)

(72) Inventor: Conor FORKAN, Toronto (CA)

(21) Appl. No.: 16/936,793

(22) Filed: Jul. 23, 2020

Related U.S. Application Data
(60) Provisional application No. 62/877,500, filed on Jul. 23, 2019.

(51) Int. Cl. A47G 21/06; A47G 21/02

(52) U.S. Cl. CPC A47G 21/06; A47G 2021/002; A47G 21/02

(57) ABSTRACT

A compact cutlery set is provided, including a case having at least one recess, each of the at least one recess having two lateral sides extending longitudinally, the two lateral sides defining a plane. At least one collapsible utensil has a handle and a tool member extendibly coupled to the handle between a collapsed configuration and a use configuration. Longitudinally extending lateral sides of each of the at least one collapsible utensil and the lateral sides of a corresponding one of the at least one recess have engagement features inhibit travel of the collapsible utensil out of plane when positioned in the recess in the collapsed configuration.

### CROSS-REFERENCE TO RELATED APPLICATIONS

This application claims the benefit of U.S. Provisional Application No. 62/877,500, filed Jul. 23, 2019, the contents of which are incorporated herein by reference in their entirety.

### FIELD

The specification relates generally to tools, and, in particular, to a compact cutlery set.

### SUMMARY OF THE DISCLOSURE

In one aspect, there is provided a compact cutlery set, comprising: a case having at least one recess, each of the at least one recess having two lateral sides extending longitudinally, the two lateral sides defining a plane; and at least one collapsible utensil having a handle and a tool member extendibly coupled to the handle between a collapsed configuration and a use configuration, wherein lateral sides of each of the at least one collapsible utensil and the lateral sides of a corresponding one of the at least one recess have engagement features that inhibit travel of the collapsible utensil out of plane when positioned in the recess in the collapsed configuration.

The lateral sides of the at least one recess can extend longitudinally.

The engagement features can include one or more protrusions and one or more corresponding channels. The handle of each of the at least one collapsible utensil can be formed from a pair of panels that extend between the lateral sides of the corresponding one of the at least one recess when the collapsible utensil is positioned therein, the pair of panels defining a channel along at least one lateral side of the collapsible utensil. A bridging member can bridge the pair of panels.

The corresponding recess can include at least one protrusion that is received within the longitudinally extending channel.

The handle of each of the at least one collapsible utensil can be formed from a pair of panels that extends between the lateral sides of the corresponding one of the at least one recess when the collapsible utensil is positioned therein, and the tool member can extend out laterally from the pair of panels to provide one or more protrusions that are received within one or more channels of the corresponding recess. The tool member can be a knife blade that extends laterally to provide protrusions that are received in channels along the lateral sides of the corresponding recess. The knife blade can have a blunt point.

The tool member can be a fork having tines that act as protrusions that are received in channels along the lateral sides of the corresponding recess.

An end of the at least one recess and an end of the at least one collapsible utensil can include engagement features that inhibit travel of the collapsible utensil out of plane when positioned in the recess in the collapsed configuration. The engagement features can include one or more protrusions and one or more corresponding apertures.

In another aspect, there is provided a compact cutlery set, comprising: a case having at least one recess, each of the at least one recess having two lateral sides, each of the lateral sides having one of a channel and a tab extending along at least a portion of the lateral side; and at least one collapsible utensil having a handle and a tool member extendibly coupled to the handle between a collapsed configuration and a use configuration, the at least one collapsible utensil being securely received in the compact position in the at least one recess of the case in the collapsed configuration.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 shows a compact cutlery set in accordance with one embodiment thereof;

FIG. 2 the compact cutlery set of FIG. 1 with collapsible utensils thereof withdrawn from a case thereof and opened to a use configuration;

FIG. 3 shows a compact cutlery set in accordance with another embodiment thereof; and

FIG. 4 the compact cutlery set of FIG. 3 with collapsible utensils thereof withdrawn from a case thereof and opened to a use configuration.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

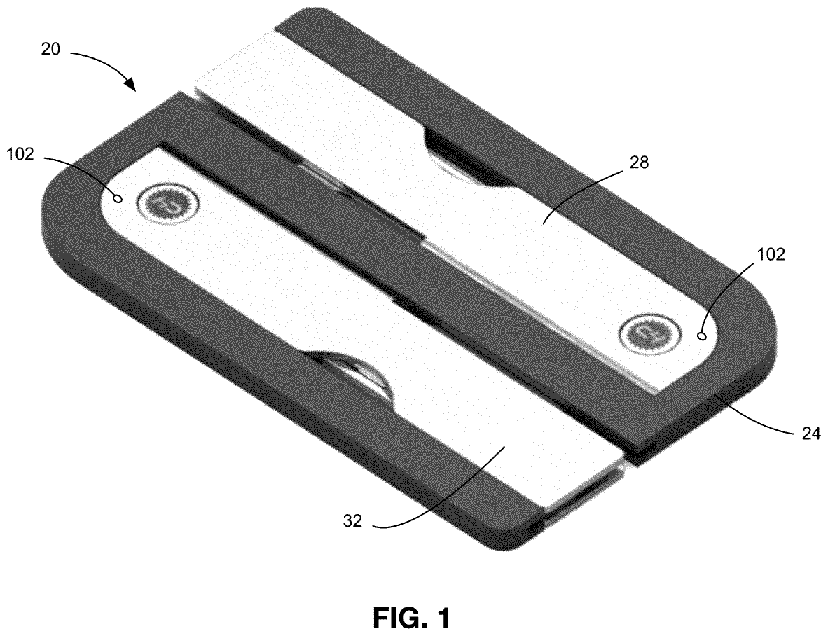

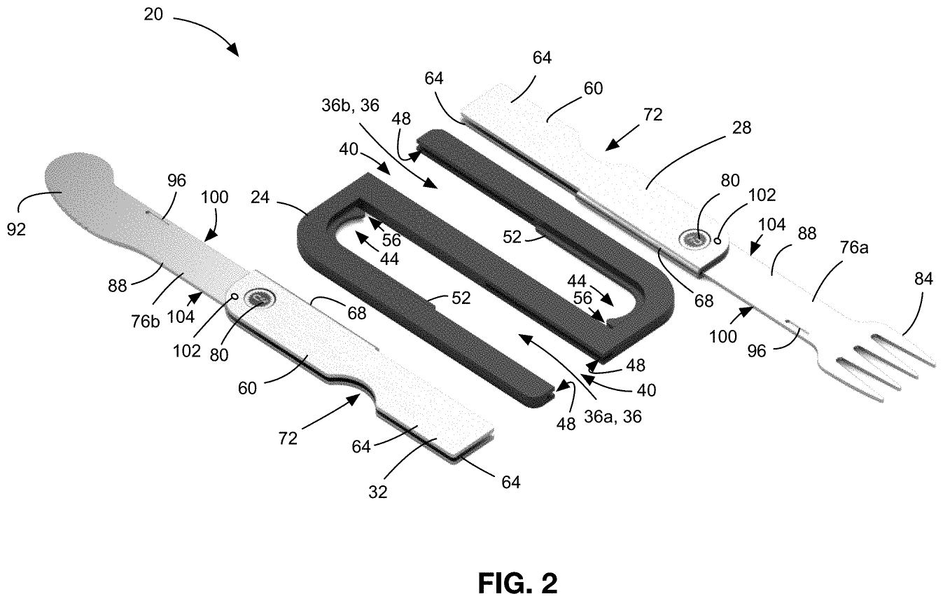

A compact cutlery set 20 in accordance with an embodiment is shown in FIGS. 1 and 2. The compactable cutlery set 20 includes a case 24 and two collapsible utensils in the form of a collapsible fork 28 and a collapsible knife 32. The case 24 is a generally S-shaped unitary member that is made of plastic via molding or another suitable method, but can also be made of another material, such as a metal, can be made of two or more elements assembled together, etc. The S-shaped member of the case 24 defines two recesses 36a, 36b, corresponding ones of which are configured to receive the collapsible fork 28 and the collapsible knife 32 when collapsed in a collapsed configuration, and may be alternatively referenced as recesses 36 hereinafter. In other embodiments, the case can include one or three or more recesses. Each recess 36 is open on a top and bottom and has two lateral side walls defined by the S-shaped member and extending longitudinally, and has an open longitudinal end 40 where the recess 36 opens and a back longitudinal end 44 where the recess 36 is closed. A channel 48 extends from the open end 40 and partway along and parallel to each of two side walls of the recesses 36. A protrusion in the form of a tab 52 extends partway along one of the side walls towards a back end 44 and partway along a rear side wall at the back end 44 of the recess 36. A gap 56 separates the tab 52 from the other of the side walls. The tab 52 extending along the rear side wall at the back longitudinal end 44 has an arcuate depression.

Each of the collapsible fork 28 and the collapsible knife 32 have handles 60 formed from a single sheet of metal. The handles 60 include two generally planar panels 64 that are connected via a bridging member 68 at least partway along one side thereof. Each of the panels 64 has a depression 72.

A tool member 76 is pivotally connected at a first end thereof to each of the handles 60 via a rivet 80 or other suitable pivot connection that extends between the panels 64. A second end of each tool member 76 terminates in a working tool end. In particular, the tool member 76 of the collapsible fork 28 terminates in a fork head 84 having a set of tines. The fork head 84 is extends further laterally along both sides than a neck 88 of the tool member 76. Similarly, the tool member 76 of the collapsible knife 32 terminates in a blade 92 that extends further laterally along both sides than a neck 88 of the tool member 76. The blade 92 is shaped with a blunt point and extends laterally in both directions. A gripping groove 96 is formed on each flat side of the tool members 76 adjacent to and along a lateral side 100 thereof.

Abutment of the lateral side 100 of the tool members 76 against the bridging members 68 limit rotation of the tool members 76 in one angular direction when the collapsible fork 28 and the collapsible knife 32 are in a use position shown in FIG. 2. Dimples 102 stamped into the handles 60 align with a recess in the tool members 76 to provide resistance to being pivoted once the collapsible fork 28 and the collapsible knife 32 are in the use configuration. In other embodiments, any other type of configuration locking feature that inhibits the accidental transition from the use configuration to the collapsed configuration can be employed.

When it is desired to place the collapsible fork 28 and the collapsible knife 32 into the case 24, the tool members 76 are pivoted about the rivets 80 to bring the tool members 76 between the panels 64 of the handles 60 into a collapsed configuration. Abutment of a second lateral side 104 of each of the tool members 76 with the bridging members 68 of the handles 60 limits pivoting of the tool members 76 so that the tool members 76 are generally parallel to and generally hidden between the panels 64. In this position, the working utensil end of each of the tool members 76 extends laterally beyond the sides of the panels 64. That is, the fork head 84 extends laterally beyond the panels 64 of the handle 60 of the collapsible fork 28 when the tool member 76 is pivoted to a collapsed configuration as shown in FIG. 1. Similarly, the blade 92 extends laterally beyond the panels 64 of the handle 60 of the collapsible knife 32 when the tool member 76 is pivoted to a collapsed configuration as shown in FIG. 1. The gripping grooves 96 can be used to pivot the tool members 76 from the collapsed configuration out of the handles 60 and back to the use configuration shown in FIG. 2.

Once the tool members 76 of the collapsible fork 28 and the collapsible knife 32 are pivoted to the collapsed configuration, the collapsible fork 28 and the collapsible knife 32 can be slid into the recesses 36 of the case 24 with the longitudinal end of the collapsible fork 28 and collapsible knife 32 having the rivet 80 being inserted first and with the bridging members being aligned laterally with the gaps 56. As the collapsible utensils 28, 32 are slid fully into the case 24, the bridging members 68 act as engagement members to seat within the gaps 56. Further, the tabs 52 act as engagement members and seat between another engagement member in the form of a channel formed by the panels 64 with the arcuate depressions in the tabs 52 along the back side walls of the recesses 36 of the case 24 receiving rounded ends of the tool members 76. Further, the wide fork head 84 and the wide blade 92 slide into the channels 48 along each lateral side wall. That is, the fork head 84 and the blade 92 act as engagement members with the channels 48.

When the collapsible utensils 28, 32 are positioned within the case 24 as shown in FIG. 1, the ends of the collapsed utensils 28, 32 at the back ends 44 of the recesses 36 are inhibited from shifting out of the recesses 36 by the tabs 52 seated between the panels 64 and the placement of the bridging members 68 in the gaps 56 between the side walls of the recesses 36 and the tabs 52. Further, the other ends of the collapsed utensils 28, 32 are restricted from shifting out of the recesses 36 by positioning of the wide fork head 84 and blade 92 within the channels 48. That is, the collapsible utensils 28, 32 are inhibited from travelling out of a plane defined between the lateral sides of the recesses 36.

As a result, the case 24 is provided some rigidity and resistance to separation of the collapsed utensils 28, 32 from the case.

The pivots 80 can be placed within recesses of the handles 60 to enable gripping of the collapsed utensils 28, 32 when in the case 24 to slide them out of the case 24.

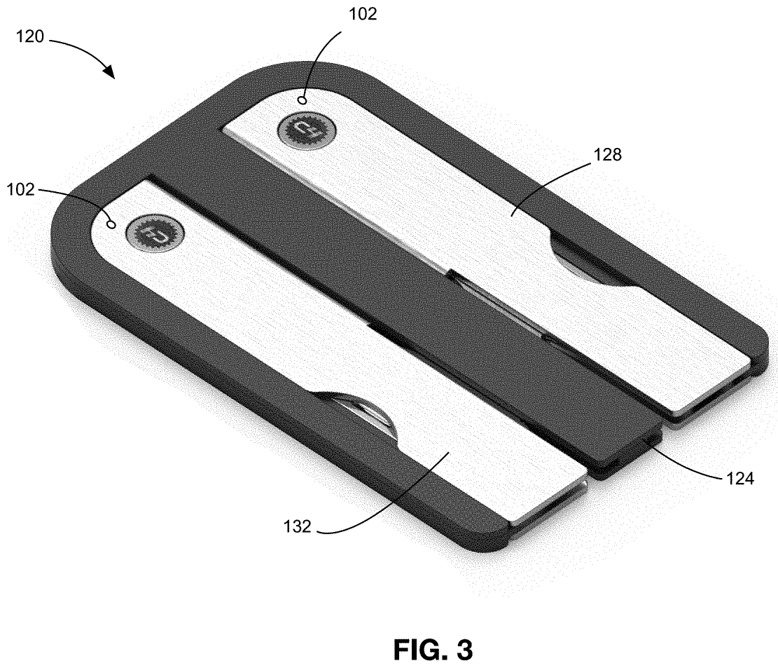

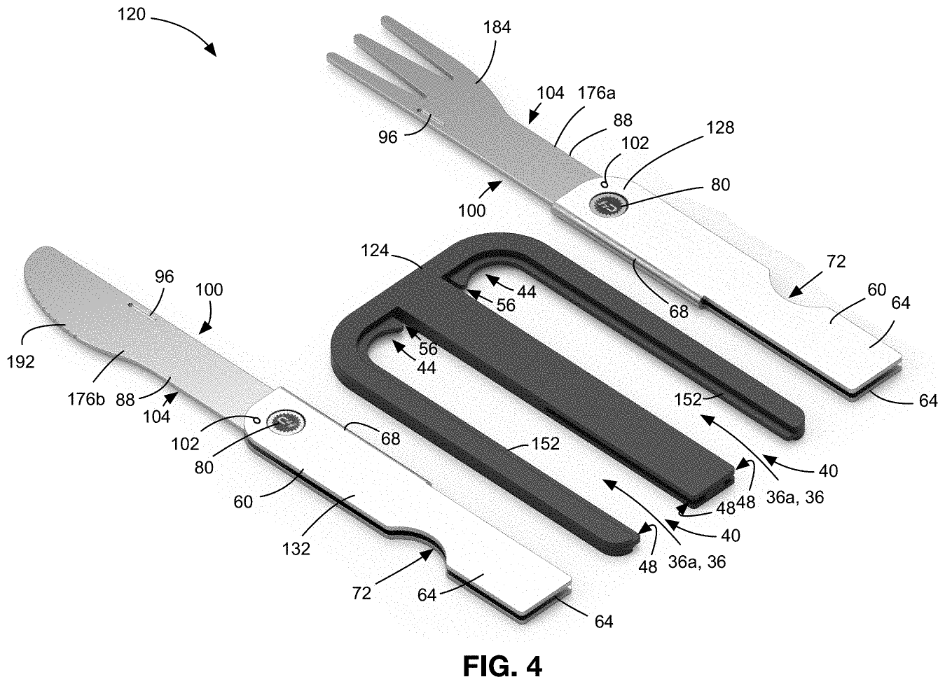

FIGS. 3 and 4 show a compact cutlery set 120 in accordance with another embodiment. Many of the features of the compact cutlery set 120 are similar to those of the compact cutlery set 20 of FIGS. 1 and 2, and are referenced using the same reference numerals. The compact cutlery set 120 has a case 124 that is E-shaped, with the recesses 36 extending from the same longitudinal end thereof. Each of the recesses 36 have a single channel 48 in a lateral side wall thereof, and have a tab 152 that extends from the open end 40 of the recess 36 to the back end 44 and along the rear side wall.

A collapsible fork 128 and a collapsible knife 132 have tool members 176a, 176b similar to the tool members 76a, 76b shown in FIGS. 1 and 2, but that vary somewhat. In particular, the working utensil ends of the tool members 176a, 176b extend laterally from the neck 88 along one lateral side 104. In particular, a fork head 184 of the collapsible fork 128 is shown being enlarged along one side of the neck 88 of the corresponding tool member 176a, and a blade 192 of the collapsible knife 132 is shown being enlarged along one side of the neck 88 of the corresponding tool member 176b.

When the collapsible utensils 128, 132 are folded from the use configuration shown in FIG. 4 to the collapsed configuration shown in FIG. 3, the fork head 184 and the blade 192 extend laterally from the handles 60 along one side thereof. The collapsible utensils 128, 132 are then slid into the case 124 so that the laterally extending portions of the fork head 184 and the blade 192 are received within the single channels 48, and the tabs 152 along sides of the recesses 36 are received between the panels 64 of the handles 60 along the entire length of the collapsible utensils 128, 132 when in the collapsed configuration shown in FIG. 3.

As will be appreciated, when the collapsible utensils 128, 132 are positioned within the case 124 as shown in FIG. 3, the ends of the collapsed utensils 128, 132 at the back ends 44 of the recesses 36 are inhibited from shifting out of the recesses 36 by the tabs 152 seated between the panels 64 and the placement of the bridging members 68 in the gaps 56 between the side walls of the recesses 36 and the tabs 152. Further, the other ends of the collapsed utensils 128, 132 are restricted from shifting out of the recesses 36 by positioning of the portions of the wide fork head 184 and blade 192 extending laterally from one side of the handles 60 within the channels 48, and by positioning of the tabs 152 between the panels 64 of the handles 60.

In other embodiments, the cases can have one or more recesses to accommodate one or more collapsible utensils.

The tool members can be extendibly coupled to the handles in other manners. For example, one of the tool members and the handles can have at least one elongated slot, and the other of the tool members and the handles can have at least one projection received within the at least one elongated slot to allow the tool members to slidingly extend from the handles from a collapsed position to a use position. Locking features can be provided to secure the tool members in their use position.

In other embodiments, the recesses can be open along a longer end thereof.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. A compact cutlery set, comprising:
a case having at least one recess, each of the at least one recess having two lateral sides extending longitudinally, the two lateral sides defining a plane; and
at least one collapsible utensil having a handle and a tool member extendibly coupled to the handle between a collapsed configuration and a use configuration,
wherein lateral sides of each of the at least one collapsible utensil and the lateral sides of a corresponding one of the at least one recess have engagement features that inhibit travel of the collapsible utensil out of plane when positioned in the recess in the collapsed configuration.

2. The compact cutlery set of claim 1, wherein the lateral sides of the at least one recess extend longitudinally.

3. The compact cutlery set of claim 1, wherein the engagement features include one or more protrusions and one or more corresponding channels.

4. The compact cutlery set of claim 3, wherein the handle of each of the at least one collapsible utensil is formed from a pair of panels that extend between the lateral sides of the corresponding one of the at least one recess when the collapsible utensil is positioned therein, the pair of panels defining a channel along at least one lateral side of the collapsible utensil.

5. The compact cutlery set of claim 4, wherein a bridging member bridges the pair of panels.

6. The compact cutlery set of claim 4, wherein the corresponding recess includes at least one protrusion that is received within the longitudinally extending channel.

7. The compact cutlery set of claim 3, wherein the handle of each of the at least one collapsible utensil is formed from a pair of panels that extends between the lateral sides of the corresponding one of the at least one recess when the collapsible utensil is positioned therein, and wherein the tool member extends out laterally from the pair of panels to provide one or more protrusions that are received within one or more channels of the corresponding recess.

8. The compact cutlery set of claim 7, wherein the tool member is a knife blade that extends laterally to provide protrusions that are received in channels along the lateral sides of the corresponding recess.

9. The compact cutlery set of claim 8, wherein the knife blade has a blunt point.

10. The compact cutlery set of claim 7, wherein the tool member is a fork having tines that act as protrusions that are received in channels along the lateral sides of the corresponding recess.

11. The compact cutlery set of claim 1, wherein an end of the at least one recess and an end of the at least one collapsible utensil include engagement features that inhibit travel of the collapsible utensil out of plane when positioned in the recess in the collapsed configuration.

12. The compact cutlery set of claim 11, wherein the engagement features include one or more protrusions and one or more corresponding apertures.

13. A compact cutlery set, comprising:
a case having at least one recess, each of the at least one recess having two lateral sides, each of the lateral sides having one of a channel and a tab extending along at least a portion of the lateral side; and
at least one collapsible utensil having a handle and a tool member extendibly coupled to the handle between a collapsed configuration and a use configuration, the at least one collapsible utensil being securely received in the compact position in the at least one recess of the case in the collapsed configuration.
